(19) United States
(12) Patent Application Publication
(10) Pub. No.: US 2024/0359307 A1
(43) Pub. Date: Oct. 31, 2024

(54) Power Tool Attachment

(71) Applicant: Eric Rocklitz, Minneapolis, MN (US)

(72) Inventor: Eric Rocklitz, Minneapolis, MN (US)

(21) Appl. No.: 18/651,694

(22) Filed: May 1, 2024

Related U.S. Application Data
(60) Provisional application No. 63/499,245, filed on Apr. 30, 2023.

(51) Int. Cl. B25F 5/02

(52) U.S. Cl. CPC B25F 5/029

(57) ABSTRACT

An attachment for a power tool. The attachment including a containing and an attachment mechanism attached to the container. The attachment mechanism configured to attach to an attachment point of a power tool. The container having a bottom and at least one side, including a first side, wherein the first side includes a magnetized region, the magnetized region configured to magnetically hold installable components to the magnetized region, the magnetized region positioned such that, when dislodged from the magnetized region, the dislodged installable components fall into the bottom of the container.

This disclosure pertains generally to power tools and, in particular, to ways to increase the efficiency and safety of handheld power tools used to install or remove installable components such as screws, bolts, nuts, or other fasteners.

### BACKGROUND

Power tools are used at jobsites and in projects by carpenters, electricians, mechanics, and hobbyists for tightening, securing and loosening various fasteners. Screws or nuts and bolts are used instead of nails or staples in many applications. A power tool such as a power drill or driver speeds up much of this work and is faster than a ratchet wrench.

### BRIEF DESCRIPTION OF THE DRAWINGS

Embodiments of the disclosure may be better understood by referencing the accompanying drawings.

FIG. 1 illustrates an attachment configured to hold both adapter bits for power tools and components such as fasteners, according to aspects of the present disclosure.

FIG. 2 illustrates an example of an attachment of FIG. 1 fastened to a power tool, according to aspects of the present disclosure.

FIG. 3 is an exploded view of attachment and power tool, according to aspects of the present disclosure.

FIG. 4 is an alternate view of the attachment of FIG. 1, according to aspects of the present disclosure.

FIG. 5 illustrates another example of an attachment fastened to a power tool, according to aspects of the present disclosure.

FIG. 6 is an exploded view of attachment 500 and power tool 600 of FIG. 5, according to aspects of the present disclosure.

FIGS. 7A and 7B illustrate aspects of the attachment of FIGS. 1-4, according to aspects of the present disclosure.

Like reference numbers and designations in the various drawings indicate like elements.

### DETAILED DESCRIPTION

Multiple drill bits, screws, bolts, nuts, or other fasteners or installable components are often used on a single job. To speed installation, an installer may carry various components stored in a bin, pouch, or pocket prior to installation. The installer then grabs an installable component from say a pocket, mounts it to the drill or driver, and installs it. Having the required installable components accessible from the handheld drill or driver increases speed and efficiency.

In addition, the different fastener types may require that different specific adapter bits be inserted into the drill chuck or bit holder prior to installing that fastener. Workers may have to continually install and remove drill bits as they move between a variety of fasteners. The process of chucking and unchucking must be repeated for each type of drill or fastener, reducing speed and efficiency. It would be advantageous to have the required fastener components and adapter bits easily accessible, increasing speed and efficiency.

Installers often are on ladders, or in other positions where it may be difficult or dangerous to reach into a pouch or pocket for a fastener component. Having the required installable components accessible from the hand held drill or driver increases installer safety by eliminating the need to reach into pockets or pouches. Installation speed, efficiency, and installer safety are expected to increase from a device attached to a handheld drill or driver that makes drills, bits, screws, nuts, bolts, or other fasteners and installable components more easily accessed.

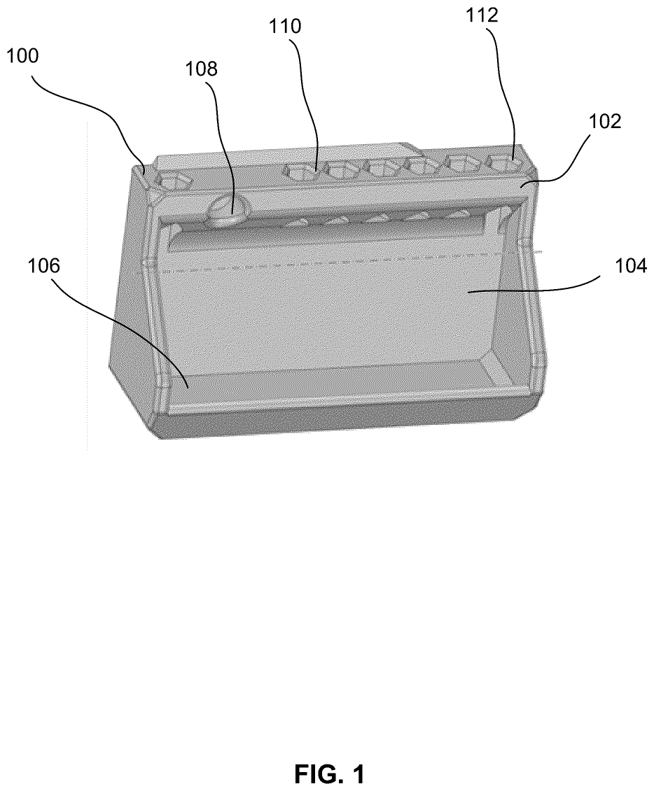

FIG. 1 illustrates an attachment configured to hold both adapter bits for power tools and components such as fasteners, according to aspects of the present disclosure. In the example shown in FIG. 1, attachment 100 includes a magnetized tool bit region 102 adapted to receive one or more tool bits, a magnetized component region 104 adapted to receive one or more components and a bin region 106 adapted to receive non-magnetic installable components and/or components that fell into bin region 106 or that were dislodged from magnetized component region 104. In one example approach, attachment 100 includes a through hole 108 used to fasten attachment 100 to a power tool. In the example shown in FIG. 1, magnetized tool bit region 102 includes one or more apertures 110 and one or more apertures 112. Apertures 110 include a stop mechanism and may be used to store shorter tool bits, while apertures 112 accommodate longer tool bits including, in some example approaches, tool bits that extend to through aperture 112 to bin region 106.

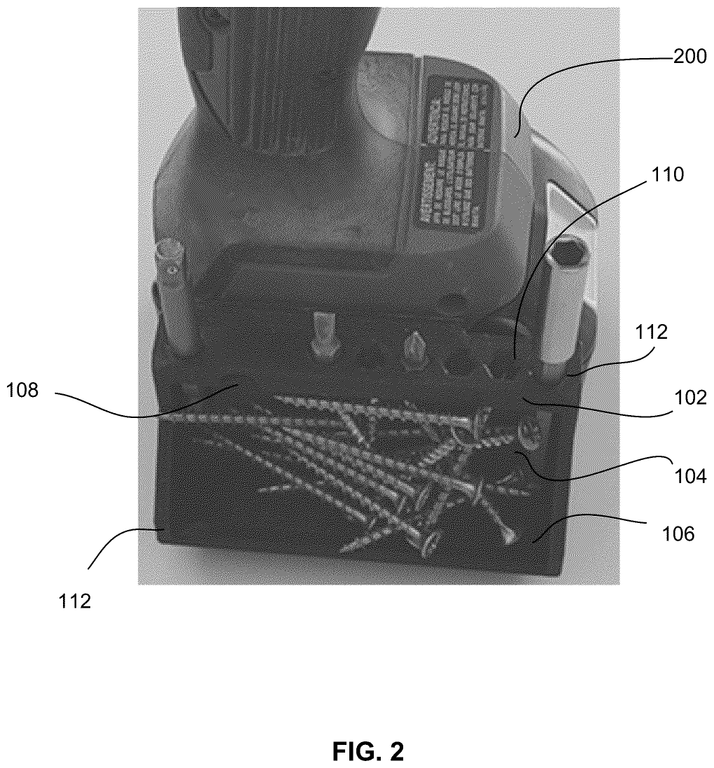

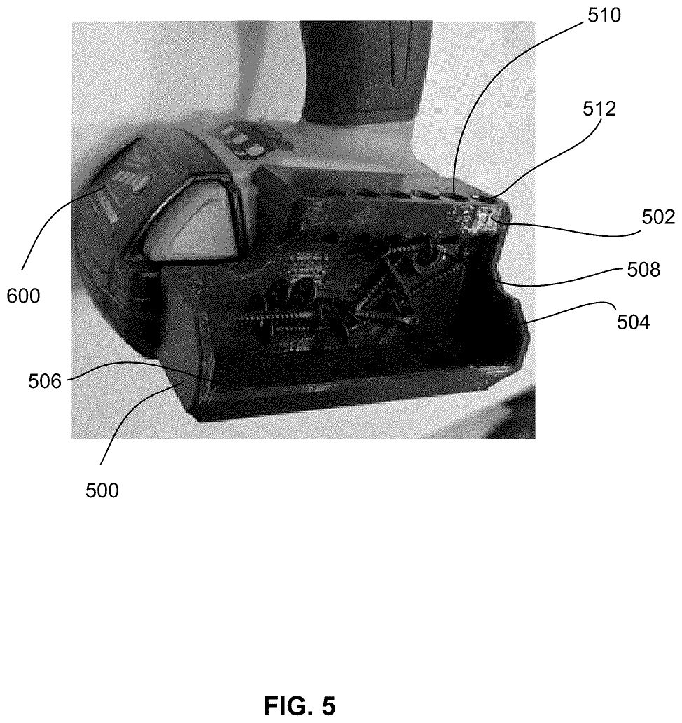

Power tools often have a belt clip. The belt clip is typically a metal clip. The metal clip is removable from the power tool, and designed to be attached to one side or the other of the power tool to accommodate left or right handed use. The attachment region on the power tool typically consists of a threaded section to accept a bolt, to bolt the clip to the power tool, and some geometry to stop the metal clip from twisting and allow the full weight of the power tool to be transferred from the belt clip to the power tool body (see, for example, FIGS. 2 and 5).

FIG. 2 illustrates an example of an attachment of FIG. 1 fastened to a power tool, according to aspects of the present disclosure. In the example shown in FIG. 2, the attachment 100 is fastened to a power tool 200 at through hole 108. The power tool 200 in FIG. 2 may be any power tool, such as a handheld drill, hammer driver, impact driver, or similar device that installs or removes screws, bolts, nuts, or other fasteners and installable components. holding one or more magnetically attached screws and tool bits. Note: In the example of FIG. 2, the screws are held in region 104 above the bottom of the bin region 106 by magnets. Both the tool bits and screws are easily accessed from regions 102 and 104, respectively.

Various examples are disclosed. In one example approach, the attachment 100 has two or more of the following three features:
Region a) A magnetized region such as magnetized component region 104 that magnetically holds one or more the installable components to the magnetized component region 104.
Region b) A tool bit region such as magnetized tool bit region 102 that holds interchangeable adapter bits within the tool bit region.
Region c) A bin region such as bin region 106 that holds non-magnetic components, and/or catches installable components that may be dislodged from the first magnetized component holding region.

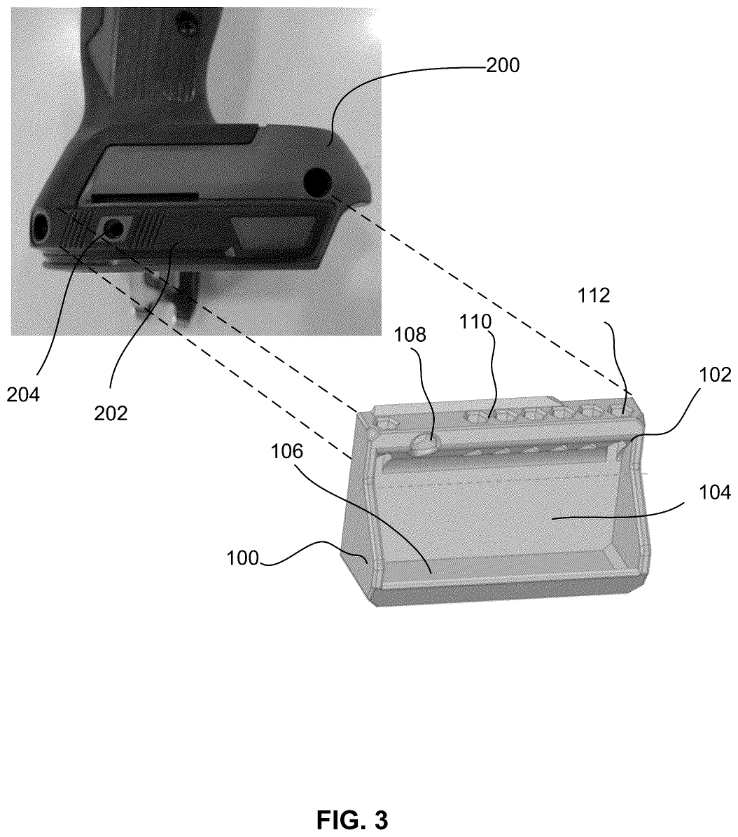

In one example approach, the attachment 100 is mounted to the power tool. One method of mounting the attachment to the power tool is to utilize the threaded bolt hole and geometry of one of the two belt clip attachment points typically found on a power tool. The attachment 100 may also include the following feature:
Region d) An adapter region such as through hole 108 adapted for each power tool, that mates the geometry of the attachment to the geometry of the side of the specific power tool such that the user may utilize a bolt to draw the attachment to the side of the power tool at a point of belt clip attachment (such as shown in FIGS. 3 and 5). In one example approach, the adapter region conforms to the geometry of the power tool in such a manner to stop the attachment from twisting relative to the power tool, and such that the conforming geometry transfers some portion of the weight of the attachment to the body of the power tool. In one such example approach, the adapter region may be a permanent part of the attachment or may include a separate part that is mounted to the attachment to adapt the attachment to specific power tools.

The elements, features, and advantages of one or more embodiments will be more readily understood upon consideration of the following description, taken in conjunction with the accompanying drawings, in which embodiments, including details, conceptual elements, and current practices, are illustrated by way of example. It is to be understood, however, that the drawings are for illustration and description only and are not intended as a definition of the limits of the embodiments and conceptual basis as claimed. The various elements, features, steps, and combinations thereof that characterize aspects of the claimed matter are pointed out with particularity in the claims annexed to and forming part of this disclosure.

In one example approach, the installable components and adapter bits are made from a material attracted to magnets. In one such example approach, the attachment has two features: a) a component region 104 that holds interchangeable adapter bits and b) a tool bit region 102 that stores adapter bits such as screwdriver bits of various patterns, bolt driver bits of various patterns, short or long shafted socket adapters for use with nuts and bolts, and other such bit configurations. The tool bit region 102 may be magnetized to securely hold adapter bits, or may use friction fit, detents, or spring mechanisms to securely hold the adapter bits to the attachment.

In a second example approach, attachment 100 includes three features: a) a component region 104 that holds interchangeable adapter bits, b) a tool bit region 102 that stores adapter bits such as screwdriver bits of various patterns, bolt driver bits of various patterns, short or long shafted socket adapters for use with nuts and bolts, and other such bit configurations, and c) a bin region 106 that holds non-magnetic components, and/or catch installable components that may be dislodged from the magnetized component region 104. The bin region 106 may or may not be magnetized. Generally, the bin region 106 is adjacent to and below (in the direction of gravity) the magnetized component region 104.

In a third example approach, attachment 100 includes two features: a) a component region 104 that holds interchangeable adapter bits and c) a bin region 106 that holds non-magnetic components, and/or catch installable components that may be dislodged from the magnetized component region 104. The bin region 106 may or may not be magnetized. Generally, the bin region 106 is adjacent to and below (in the direction of gravity) the magnetized component region 104.

In a fourth example approach, attachment 100 includes two features: b) a tool bit region 102 that stores adapter bits such as screwdriver bits of various patterns, bolt driver bits of various patterns, short or long shafted socket adapters for use with nuts and bolts, and other such bit configurations, and c) a bin region 106 that holds non-magnetic components, and/or catch installable components that may be dislodged from the magnetized component region 104. The bin region 106 may or may not be magnetized. Generally, the bin region 106 is adjacent to and below (in the direction of gravity) the magnetized component region 104.

In one or more example approaches, attachment 100 is attached to the drill or driver (200) by, for instance, screws or bolts, glue, Velcro or other means, in such a manner that the attachment 100 generally moves with the drill or driver (200) and is not easily bumped loose.

FIG. 3 is an exploded view of attachment 100 and power tool 200, according to aspects of the present disclosure. In the example shown in FIG. 3, attachment 100 is configured to attach to a belt clip attachment point 202 of power tool 200. In one example approach, the attachment 100 is mounted to the power tool. In one example approach, one method of mounting the attachment 100 to the power tool 200 is to utilize the threaded bolt hole 204 and geometry of one of the two belt clip attachment points 202 typically found on a power tool 200 (here, a specific Makita power tool). As noted above, attachment 100 may also include an adapter region, including a through hole 108 adapted for each power tool 200, that mates the geometry of the attachment to the geometry of the side of the specific power tool such that the user may utilize a bolt threaded into threaded bolt hole 204 to draw the attachment 100 to the side of the power tool at a point of belt clip attachment 202 (such as shown in FIGS. 3 and 5). In one example approach, the adapter region conforms to the geometry of the power tool in such a manner to stop the attachment from twisting relative to the power tool, and such that the conforming geometry transfers some portion of the weight of the attachment to the body of the power tool. In one such example approach, the adapter region may be a permanent part of the attachment or may include a separate part that is mounted to the attachment to configure the attachment 100 for specific power tools 200.

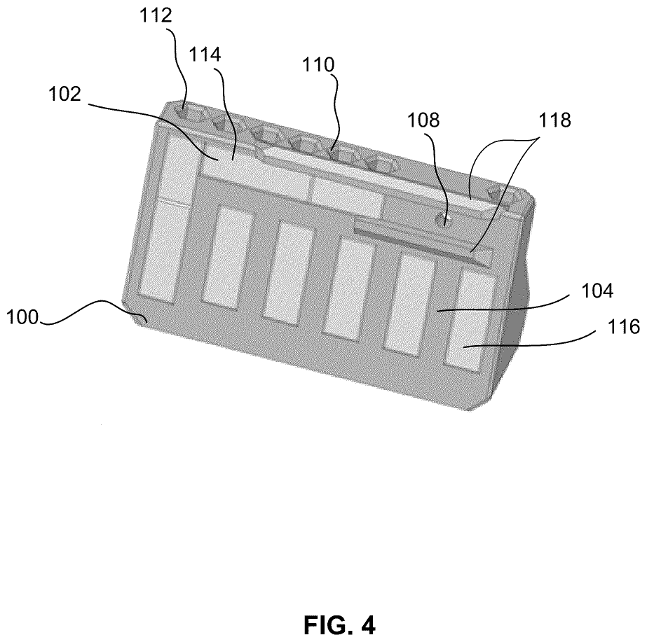

FIG. 4 is an alternate view of the attachment of FIG. 1, according to aspects of the present disclosure. In the example shown in FIG. 4, a through hole 108 in the attachment allows users to attach the belt clip attachment via a bolt in through hole 108 to the bolt hole 204 provided for a belt clip. Note: Each model of power tool from each manufacturer may have a different belt clip attachment point and different body geometry. The example approaches shown in FIGS. 2-4 are for a specific Makita brand power tool 200 and include conforming geometry 118 of the power tool 200 in such a manner to stop the attachment 100 from twisting relative to the power tool 200, and such that some or all of the conforming geometry 118 transfers portions of the weight of the attachment 100 to the body of the power tool 200.

As can be seen in the example approach of FIG. 4, attachment 100 includes magnetized tool bit region 102 and magnetized component region 104. In one example approach, regions 102 and 104 are magnetized by fastening magnetic strips to slots on the back of attachment 100. Magnetic strips 114 in the vicinity of region 102 magnetize magnetic tool bit region 102 while magnetic strips 116 in magnetized component region 104 magnetize magnetic component region 106.

FIG. 5 illustrates another example of an attachment fastened to a power tool, according to aspects of the present disclosure. In the example shown in FIG. 5, the attachment 500 is fastened to a power tool 600 at through hole 508. In the example shown the power tool is a Milwaukee brand power drill. The power tool 600 in FIG. 5 may, however, be any power tool, such as a handheld drill, hammer driver, impact driver, or similar device that installs or removes screws, bolts, nuts, or other fasteners and installable components. holding one or more magnetically attached screws and tool bits. (In the example of FIG. 5, the screws are held in region 504 above the bottom of the bin region 506 by magnets. Both the tool bits and screws are easily accessed from regions 502 and 504, respectively.

Various examples are disclosed. In one example approach, the attachment 500 has two or more of the following three features:
Region a) A magnetized region such as magnetized component region 504 that magnetically holds one or more the installable components to the magnetized component region 104.
Region b) A tool bit region such as magnetized tool bit region 502 that holds interchangeable adapter bits within the tool bit region.
Region c) A bin region such as bin region 506 that holds non-magnetic components, and/or catches installable components that may be dislodged from the first magnetized component holding region.

In one example approach, the attachment 500 is mounted to the power tool. One method of mounting the attachment to the power tool is to utilize the threaded bolt hole and geometry of one of the two belt clip attachment points typically found on a power tool. The attachment 500 may also include the following feature:
Region d) An adapter region such as through hole 508 adapted for each power tool, that mates the geometry of the attachment to the geometry of the side of the specific power tool such that the user may utilize a bolt to draw the attachment to the side of the power tool at a point of belt clip attachment (such as shown in FIGS. 3 and 5). In one example approach, the adapter region conforms to the geometry of the power tool in such a manner to stop the attachment from twisting relative to the power tool, and such that the conforming geometry transfers some portion of the weight of the attachment to the body of the power tool. In one such example approach, the adapter region may be a permanent part of the attachment or may include a separate part that is mounted to the attachment to adapt the attachment to specific power tools.

The elements, features, and advantages of one or more embodiments will be more readily understood upon consideration of the following description, taken in conjunction with the accompanying drawings, in which embodiments, including details, conceptual elements, and current practices, are illustrated by way of example. It is to be understood, however, that the drawings are for illustration and description only and are not intended as a definition of the limits of the embodiments and conceptual basis as claimed. The various elements, features, steps, and combinations thereof that characterize aspects of the claimed matter are pointed out with particularity in the claims annexed to and forming part of this disclosure.

In one example approach, the installable components and adapter bits are made from a material attracted to magnets. In one such example approach, the attachment has two features: a) a component region 504 that holds interchangeable adapter bits and b) a tool bit region 502 that stores adapter bits such as screwdriver bits of various patterns, bolt driver bits of various patterns, short or long shafted socket adapters for use with nuts and bolts, and other such bit configurations. The tool bit region 502 may be magnetized to securely hold adapter bits, or may use friction fit, detents, or spring mechanisms to securely hold the adapter bits to the attachment.

In a second example approach, attachment 500 includes three features: a) a component region 504 that holds interchangeable adapter bits, b) a tool bit region 502 that stores adapter bits such as screwdriver bits of various patterns, bolt driver bits of various patterns, short or long shafted socket adapters for use with nuts and bolts, and other such bit configurations, and c) a bin region 506 that holds non-magnetic components, and/or catch installable components that may be dislodged from the magnetized component region 504. The bin region 506 may or may not be magnetized. Generally, the bin region 506 is adjacent to and below (in the direction of gravity) the magnetized component region 504.

In a third example approach, attachment 500 includes two features: a) a component region 504 that holds interchangeable adapter bits and c) a bin region 506 that holds non-magnetic components, and/or catch installable components that may be dislodged from the magnetized component region 504. The bin region 506 may or may not be magnetized. Generally, the bin region 506 is adjacent to and below (in the direction of gravity) the magnetized component region 504.

In a fourth example approach, attachment 500 includes two features: b) a tool bit region 502 that stores adapter bits such as screwdriver bits of various patterns, bolt driver bits of various patterns, short or long shafted socket adapters for use with nuts and bolts, and other such bit configurations, and c) a bin region 506 that holds non-magnetic components, and/or catch installable components that may be dislodged from the magnetized component region 504. The bin region 506 may or may not be magnetized. Generally, the bin region 506 is adjacent to and below (in the direction of gravity) the magnetized component region 504.

In one or more example approaches, attachment 500 is attached to the drill or driver (600) by, for instance, screws or bolts, glue, Velcro or other means, in such a manner that the attachment 500 generally moves with the drill or driver (600) and is not easily bumped loose.

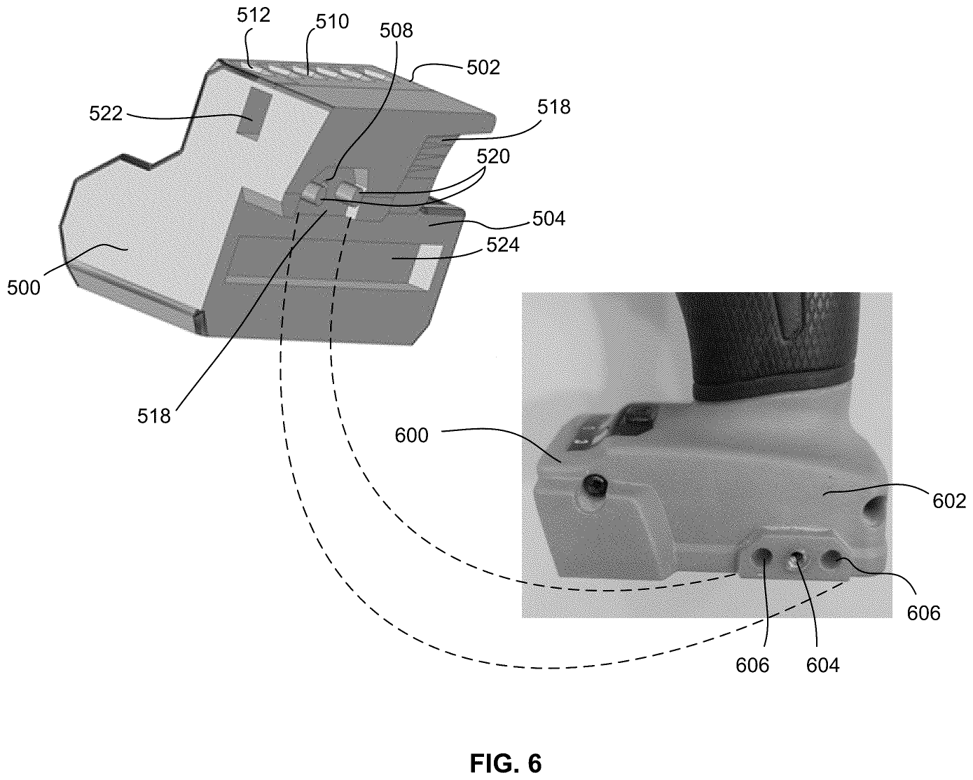

FIG. 6 is an exploded view of attachment 500 and power tool 600 of FIG. 5, according to aspects of the present disclosure. In the example shown in FIG. 6, attachment 500 is configured to attach to a belt clip attachment point 602 of power tool 600. In one example approach, the attachment 500 is mounted to the power tool. In one example approach, one method of mounting the attachment 500 to the power tool 600 is to utilize the threaded bolt hole 604 and geometry of one of the two belt clip attachment points 602 typically found on a power tool 600 (here, a specific Milwaukee brand power tool). As noted above, attachment 500 may also include an adapter region, including a through hole 508 adapted for each power tool 600, that mates the geometry of the attachment to the geometry of the side of the specific power tool such that the user may utilize a bolt threaded into threaded bolt hole 604 to draw the attachment 500 to the side of the power tool at a point of belt clip attachment 602 (such as shown in FIGS. 3 and 5). In one example approach, the adapter region conforms to the geometry of the power tool in such a manner to stop the attachment from twisting relative to the power tool, and such that the conforming geometry 518 transfers some portion of the weight of the attachment to the body of the power tool. In one such example approach, the adapter region may be a permanent part of the attachment or may include a separate part that is mounted to the attachment to configure the attachment 500 for specific power tools 600.

In the example shown in FIG. 6, magnetized tool bit region 502 includes one or more apertures 510 and one or more apertures 512. Apertures 510 include a stop mechanism and may be used to store shorter tool bits, while apertures 512 accommodate longer tool bits including, in some example approaches, tool bits that extend to through aperture 512 to bin region 506.

In one example approach, as shown in FIG. 6, a through hole 508 in the attachment allows users to attach the belt clip attachment via a bolt in through hole 508 to the bolt hole 604 provided for a belt clip. Note: Each model of power tool from each manufacturer may have a different belt clip attachment point and different body geometry. The example approaches shown in FIGS. 5 and 6 are for a specific Milwaukee brand power tool 600 and include conforming geometry 518 of the power tool 600 in such a manner to stop the attachment 500 from twisting relative to the power tool 600, and such that some or all of the conforming geometry 518 transfers portions of the weight of the attachment 500 to the body of the power tool 600.

In the example approach of FIG. 6, the conforming geometry of attachment 500 includes a pair of pegs 520 on either side of through hole 508, all recessed within attachment 500. The pegs are configured to fit into peg holes 606 in power tool 600 when attachment 500 is attached to power tool 600. The pegs 520 and the bolt in threaded bolt hole 604 stabilize a belt clip and perform the same function for attachment 500.

As can be seen in the example approach of FIG. 6, attachment 500 includes magnetized tool bit region 502 and magnetized component region 504. In one example approach, regions 502 and 504 are magnetized by fastening magnetic strips to slots 522 and 524, respectively, on the back of attachment 500. Magnetic strips in slot 522 magnetize magnetic tool bit region 502 while magnetic strips in slot 524 magnetize magnetic component region 106.

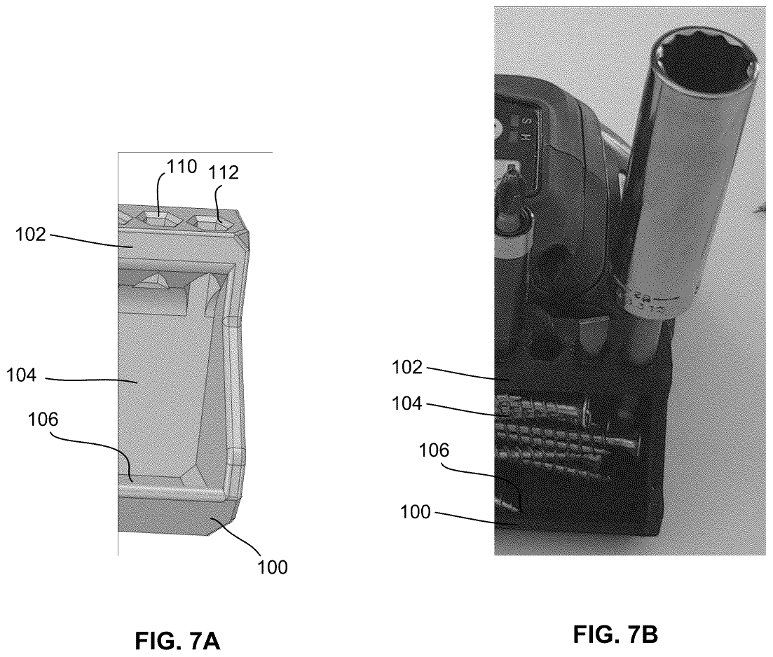

FIGS. 7A and 7B illustrate aspects of the attachment of FIGS. 1-4, according to aspects of the present disclosure. In the example shown in FIGS. 7A and 7B, attachment 100 includes magnetized tool bit region 102 includes one or more apertures 110 and one or more apertures 112. Apertures 110 include a stop mechanism and may be used to store shorter tool bits, while apertures 112 accommodate longer tool bits including, in some example approaches, tool bits that extend to through aperture 112 into bin region 106.

In the example approach of FIGS. 7A and 7B, the tool bit region 102 includes a curved or sloped ramp allowing easy removal of fasteners from the magnetized component region 104. In one example approach aperture 110 receives short bits and includes access that allows the user to push the short bit up from the bottom of aperture 110 through the bit holder. As can be seen in FIG. 7B, a flat head screwdriver bit may reside in aperture 110 while a longer socket attachment resides in aperture 112. In one such example approach, long bits received at aperture 112 are supported by the back and side walls of the bin region 106.

The drawing figures are not necessarily to scale. Certain features or components herein may be shown in somewhat schematic form and some details of conventional elements may not be shown in the interest of clarity, explanation, and conciseness. The drawing figures are hereby made part of the specification, written description and teachings disclosed herein.

Certain terms are used throughout the following description to refer to particular features, steps, or components, and are used as terms of description and not of limitation. As one skilled in the art will appreciate, different persons may refer to the same feature, step, or component by different names. Components, steps, or features that differ in name but not in structure, function, or action are considered equivalent and not distinguishable, and may be substituted herein without departure from the spirit and scope of the disclosure. The following definitions supplement those set forth elsewhere in this specification. Certain meanings are defined here as intended by the inventors, i.e., they are intrinsic meanings. Other words and phrases used herein take their meaning as consistent with usage as would be apparent to one skilled in the relevant arts. In case of conflict, the present specification, including definitions, will control.

Unless otherwise defined, all technical and scientific terms used herein have the same meaning as commonly understood by one of ordinary skill in the art to which the subject matter described herein belongs. In case of conflict, the present specification, including definitions, will control.

General connection terms including, but not limited to “connected,” “attached,” “conjoined,” “secured,” “mounted” and “affixed” are not meant to be limiting, such that structures so “associated” may have more than one way of being associated.

Relative terms should be construed as such. For example, the term “front” is meant to be relative to the term “back,” the term “upper” is meant to be relative to the term “lower,” the term “vertical” is meant to be relative to the term “horizontal,” the term “top” is meant to be relative to the term “bottom,” and the term “inside” is meant to be relative to the term “outside,” and so forth. Unless specifically stated otherwise, the terms “first,” “second,” “third,” and “fourth” are meant solely for purposes of designation and not for order or for limitation. Reference to “one embodiment,” “an embodiment,” or an “aspect,” means that a particular feature, structure, step, combination or characteristic described in connection with the embodiment or aspect is included in at least one realization of the inventive matter disclosed here. Thus, the appearances of the phrases “in one embodiment” or “in an embodiment” in various places throughout this specification are not necessarily all referring to the same embodiment and may apply to multiple embodiments. Furthermore, particular features, structures, or characteristics of the inventive matter may be combined in any suitable manner in one or more embodiments. For example, it is contemplated that features of dependent claims depending from one independent claim can be used in apparatus and/or methods of any of the other independent claims.

“Adapted to” includes and encompasses the meanings of “capable of” and additionally, “designed to”, as applies to those uses intended by the patent. In contrast, a claim drafted with the limitation “capable of” also encompasses unintended uses and misuses of a functional element beyond those uses indicated in the disclosure. Aspex Eyewear v Marchon Eyewear 672 F3d 1335, 1349 (Fed Circ 2012). “Configured to”, as used here, is taken to indicate is able to, is designed to, and is intended to function in support of the inventive structures and is thus more stringent than “enabled to”.

As used herein, the terms “include” and “comprise” are used synonymously, the terms and variants of which are intended to be construed as non-limiting.

It should be noted that the terms “may,” “can,” and “might” are used to indicate alternatives and optional features and only should be construed as a limitation if specifically included in the claims.

Claims not including a specific limitation should not be construed to include that limitation. For example, the term “a” or “an” as used in the claims does not exclude a plurality.

“Conventional” refers to a term or method designating that which is known and commonly understood in the technology to which this disclosure relates.

Unless the context requires otherwise, throughout the specification and claims that follow, the term “comprise” and variations thereof, such as, “comprises” and “comprising” are to be construed in an open, inclusive sense—as in “including, but not limited to.”

A “bin” as disclosed herein refers to a box, frame, crib, or enclosed or partially enclosed place, used as a receptacle to hold some object for easy access. The “bin” generally has a bottom and sides. The “bin” may have open access or may have an attached or detachable cover that must be moved to access the objects held therein.

A “Mounted” or “Mountable” object is capable of being connected to some other object either temporarily or permanently by some method.

Conform or conforming to the geometry means that sufficient portions of the geometry of the attachment match up somewhat close to the body of the power tool such that when the attachment is brought in contact with the power tool, the power tool makes contact with and supports some portion of the attachment.

### Examples

Example 1: An attachment mountable to a power tool, the attachment comprising:
(a) a magnetized region for magnetically retaining a plurality of installable components;
(b) an adapter bit region capable of holding adapter bits, and
(c) a bin region that may hold non-magnetic installable components and/or catch components dislodged from the magnetized region.

Example 2: The attachment of example 1, wherein the adapter bit region is a magnetized region capable of holding in place one or more adapter bits;

Example 3: The attachment of claim 1, wherein the adapter bit region is a friction rubbing region capable of holding in place one or more adapter bits;

Example 4: The attachment of claim 1, wherein the adapter bit region uses detents to hold in place one or more adapter bits.

Example 5: The attachment of claim 1, wherein the adapter bit region uses a deformable region or springs to hold in place one or more adapter bits.

Example 6: The attachment of claim 1, wherein the bin region is magnetized.

Example 7: The attachment of claim 1, wherein the bin region has an attached movable lid or cover.

Example 8: The attachment of claim 1, wherein the bin region has a removable lid or cover.

Example 9: An attachment mountable to a hand held drill, hammer driver, impact driver, or similar device that installs or removes screws, bolts, nuts, or other fasteners or installable components, which comprises:
(a) a magnetized region that may hold one or more installable components; and
(b) a tool bit region capable of holding tool bits.

Example 10: The attachment of claim 9, wherein the tool bit region is a magnetized region capable of holding in place one or more adapter bits;

Example 11: The attachment of claim 9, wherein the tool bit region is a friction rubbing region capable of holding in place one or more adapter bits;

Example 12: The attachment of claim 9, wherein the tool bit region uses detents to hold in place one or more adapter bits;

Example 13: The attachment of claim 9, wherein the tool bit region uses a deformable region or springs to hold in place one or more adapter bits;

Example 14: An attachment mountable to a handheld drill, hammer driver, impact driver, or similar device that installs or removes screws, bolts, nuts, or other fasteners or installable components, the attachment comprising:
a magnetized region that may hold one or more installable components; and
a bin region that may hold non-magnetic installable components and/or catch components dislodged from the magnetized region.

Example 15: The attachment of claim 14, wherein the bin region is also magnetized.

Example 16: The attachment of claim 14, wherein the bin region has an attached movable lid or cover.

Example 17: The attachment of claim 14, wherein the bin region has a removable lid or cover.

Example 18: An attachment mountable to a handheld drill, hammer driver, impact driver, or similar device that installs or removes screws, bolts, nuts, or other fasteners or installable components, the attachment comprising:
an adapter bit region capable of holding adapter bits, and
a bin region that may hold non-magnetic installable components and/or catch components dislodged from the magnetized region.

Example 19: The attachment of claim 18, wherein the adapter bit region is a magnetized region capable of holding in place a plurality of adapter bits;

Example 20: The attachment of claim 18, wherein the adapter bit region is a friction rubbing region capable of holding in place one or more adapter bits.

Example 21: The attachment of claim 18, wherein the adapter bit region uses detents to hold in place one or more adapter bits.

Example 22: The attachment of claim 18, wherein the adapter bit region uses a deformable region or springs to hold in place one or more adapter bits.

Example 23: The attachment of claim 18, wherein the bin region is magnetized.

Example 24: The attachment of claim 18, wherein the bin region has an attached movable lid or cover.

Example 25: The attachment of claim 18, wherein the bin region has a removable lid or cover.

Example 26: An attachment mountable to a handheld drill, hammer driver, impact driver, or similar device that installs or removes screws, bolts, nuts, or other fasteners or installable components, the attachment comprising:
a magnetized region that may hold one or more installable components;
an adapter bit region capable of holding adapter bits, and
a bin region that may hold non-magnetic installable components and/or catch components dislodged from the magnetized region.

Example 27: The attachment of claim 26, wherein the adapter bit region is a magnetized region capable of holding in place one or more adapter bits.

Example 28: The attachment of claim 26, wherein the adapter bit region is a friction rubbing region capable of holding in place one or more adapter bits.

Example 29: The attachment of claim 26, wherein the adapter bit region uses detents to hold in place one or more adapter bits.

Example 30: The attachment of claim 26, wherein the adapter bit region uses a deformable region or springs to hold in place one or more adapter bits.

Example 31: The attachment of claim 26, wherein the bin region is magnetized.

Example 32: The attachment of claim 26, wherein the bin region has an attached movable lid or cover.

Example 33: The attachment of claim 26, wherein the bin region has a removable lid or cover.

Example 34: An attachment mountable to a handheld drill, hammer driver, impact driver, or similar device that installs or removes screws, bolts, nuts, or other fasteners or installable components, the attachment comprising:
a magnetized region that may hold one or more installable components; and
a tool bit region capable of holding tool bits.

Example 35: The attachment of claim 34, wherein the tool bit region is a magnetized region capable of holding in place one or more adapter bits.

Example 36: The attachment of claim 34, wherein the tool bit region is a friction rubbing region capable of holding in place one or more adapter bits.

Example 37: The attachment of claim 34, wherein the tool bit region uses detents to hold in place one or more adapter bits.

Example 38: The attachment of claim 34, wherein the tool bit region uses a deformable region or springs to hold in place one or more adapter bits.

Example 39: An attachment mountable to a handheld drill, hammer driver, impact driver, or similar device that installs or removes screws, bolts, nuts, or other fasteners or installable components, the attachment comprising:
a magnetized region that may hold one or more installable components; and
a bin region that may hold non-magnetic installable components and/or catch components dislodged from the magnetized region.

Example 40: The attachment of claim 39, wherein the bin region is also magnetized.

Example 41: The attachment of claim 39, wherein the bin region has an attached movable lid or cover.

Example 42: The attachment of claim 39, wherein the bin region has a removable lid or cover.

Example 43: An attachment mountable to a handheld drill, hammer driver, impact driver, or similar device that installs or removes screws, bolts, nuts, or other fasteners or installable components, the attachment comprising:
a first region capable of holding adapter bits, and
a second region that may hold non-magnetic installable components and/or catch components dislodged from the magnetized region.

Example 44: The attachment of claim 43, wherein the first region is a magnetized region capable of holding in place one or more adapter bits.

Example 45: The attachment of claim 43, wherein the first region is a friction rubbing region capable of holding in place one or more adapter bits.

Example 46: The attachment of claim 43, wherein the first region uses detents to hold in place one or more adapter bits.

Example 47: The attachment of claim 43, wherein the first region uses a deformable region or springs to hold in place one or more adapter bits.

Example 48: The attachment of claim 43, wherein the second region is magnetized.

Example 49: The attachment of claim 43, wherein the second region has an attached movable lid or cover.

Example 50: The attachment of claim 43, wherein the second region has a removable lid or cover.

Example 51: An attachment mountable to a power tool, the attachment comprising:
a first region that magnetically holds a plurality of installable components;
a second region capable of holding adapter bits,
a third region that may hold non-magnetic installable components and/or catch components dislodged from the magnetized region; and
a fourth region that conforms to the power tool in such a manner that it makes use of existing attachment points (e.g., a belt clip attachment) and existing power tool contours to hold the attachment in place, to stop the attachment from twisting relative to the power tool, and to support a portion of the weight of the attachment with the body of the power tool.

Example 52: The attachment of claim 51, wherein the second region is a magnetized region capable of holding in place one or more adapter bits.

Example 53: The attachment of claim 51, wherein the second region is a friction rubbing region capable of holding in place one or more adapter bits.

Example 54: The attachment of claim 51, wherein the second region uses detents to hold in place one or more adapter bits.

Example 55: The attachment of claim 51, wherein the second region uses a deformable region or springs to hold in place one or more adapter bits.

Example 56: The attachment of claim 51, wherein the third region is a magnetized bin.

Example 57: The attachment of claim 51, wherein the third region has an attached movable lid or cover.

Example 58: The attachment of claim 51, wherein the third region has a removable lid or cover.

Example 59: The attachment of claim 51, wherein the fourth region is integral to the attachment.

Example 60: The attachment of claim 51, wherein the fourth region is separably mounted to the attachment.

Example 61: An attachment mountable to a power tool, the attachment comprising:
a first region that magnetically holds a plurality of installable components;
a second region capable of holding tool bits;
a third region that conforms to the power tool in such a manner that it makes use of existing geometry and existing attachment points (e.g., a belt clip attachment) in such a manner to support some portion of the weight of the attachment with the power tool and to stop the attachment from twisting relative to the power tool.

Example 62: The attachment of claim 61, wherein the second region is a magnetized region capable of holding in place one or more adapter bits.

Example 63: The attachment of claim 61, wherein the second region is a friction rubbing region capable of holding in place one or more adapter bits.

Example 64: The attachment of claim 61, wherein the second region uses detents to hold in place one or more adapter bits.

Example 65: The attachment of claim 61, wherein the second region uses a deformable region or springs to hold in place one or more adapter bits.

Example 66: The attachment of claim 61, wherein the third region is a permanent part of the attachment.

Example 67: The attachment of claim 61, wherein the third region is a separate part that is mounted to the attachment.

Example 68: An attachment mountable to a hand held drill, hammer driver, impact driver, or similar device that installs or removes screws, bolts, nuts, or other fasteners or installable components, the attachment comprising: (a) a magnetized region that may hold one or more installable components; and (c) a second bin region that may hold non-magnetic installable components and/or catch components dislodged from the magnetized region; and (d) a third adapter region that conforms to a power tool in such a manner that it makes use of existing attachment points (belt clip attachment) and in such a manner to stop the attachment from twisting relative to the power tool, and such that the power tool supports some portion of the weight of the attachment.

Example 69: The attachment of claim 68, wherein the second bin region (c) is also magnetized.

Example 70: The attachment of claim 68, wherein the second bin region (c) has an attached movable lid or cover.

Example 71: The attachment of claim 68, wherein the second bin region (c) has a removable lid or cover.

Example 72: The attachment of claim 68, wherein the third adapter region (d) is a permanent part of the attachment.

Example 73: The attachment of claim 68, wherein the third adapter region (d) is a separate part that is mounted to the attachment.

Example 74: An attachment mountable to a hand held drill, hammer driver, impact driver, or similar device that installs or removes screws, bolts, nuts, or other fasteners or installable components, the attachment comprising: (b) a first region capable of holding adapter bits, and (c) a second bin region that may hold non-magnetic installable components and/or catch components dislodged from the magnetized region; and (d) a third adapter region that is conforms to the power tool in such a manner that it makes use of existing attachment points (belt clip attachment) and in such a manner to stop the attachment from twisting relative to the power tool, and such that the power tool supports the weight of the attachment.

Example 75: The attachment of claim 74, wherein the first region (b) is a magnetized region capable of holding in place one or more adapter bits.

Example 76: The attachment of claim 74, wherein the first region (b) is a friction rubbing region capable of holding in place one or more adapter bits.

Example 77: The attachment of claim 74, wherein the first region (b) uses detents to hold in place one or more adapter bits.

Example 78: The attachment of claim 74, wherein the first region (b) uses a deformable region or springs to hold in place one or more adapter bits.

Example 79: The attachment of claim 74, wherein the second bin region (c) is magnetized.

Example 80: The attachment of claim 74, wherein the second bin region (c) has an attached movable lid or cover.

Example 81: The attachment of claim 74, wherein the second bin region (c) has a removable lid or cover.

Example 82: The attachment of claim 74, wherein the third adapter region (d) is a permanent part of the attachment.

Example 83: The attachment of claim 74, wherein the third adapter region (d) is a separate part that is mounted to the attachment.

Example 84: A power tool bin, the bin comprising:
an attachment mechanism configured to attach to a belt clip attachment point of a power tool; and
a container attached to the attachment mechanism, the container having a bottom and at least one side, including a first side, wherein the first side includes a magnetized region, the magnetized region configured to magnetically hold installable components to the magnetized region, the magnetized region positioned such that, when dislodged from the magnetized region, the dislodged installable components fall into the bottom of the container.

Example 85: The power tool bin of claim 84, wherein the container includes an adapter bit holding region.

Example 86: The power tool bin of claim 85, wherein the adapter bin holding area includes a friction rubbing region capable of holding in place one or more adapter bits.

Example 87: The power tool bin of claim 86, wherein the adapter bin holding area further includes a magnetized region, the magnetized region strengthening retention of the adapter bits by the friction rubbing region.

Example 88: A power tool bin, the bin comprising:
an attachment region configured to attach to a belt clip attachment point on a power tool; and
a container attached to the attachment region, the container having a bottom and at least one side, including a first side;
wherein the first side includes a first magnetized region and a second magnetized region, the first magnetized region configured to hold installable components magnetically, the second magnetized region configured to hold adapter bits magnetically, the magnetized regions positioned such that, when dislodged from the respective magnetic regions, the dislodged installable components and the dislodged adapter bits fall into the bottom of the container.

The disclosure set forth herein includes certain exemplary approaches. Various alternatives, modifications and equivalents are possible, as will readily occur to those skilled in the art in practice of the invention. The inventions, examples, and embodiments described herein are not limited to particularly exemplified materials, methods, and/or structures and various changes may be made in the size, shape, type, number and arrangement of parts described herein. It is intended that the scope of the inventions described herein be defined by the claims directed to the respective inventions and to their equivalents, while not precluding or prejudicing future applications having claims directed more broadly or more narrowly at the scope of the disclosure.

In general, in the following claims, the terms used in the written description should not be construed to limit the claims to specific embodiments described herein for illustration, but should be construed to include all possible embodiments, both specific and generic, along with the full scope of equivalents to which such claims are entitled.

1. A power tool bin, the bin comprising:
an attachment mechanism configured to attach to a belt clip attachment point of a power tool; and
a container attached to the attachment mechanism, the container having a bottom and at least one side, including a first side, wherein the first side includes a magnetized region, the magnetized region configured to magnetically hold installable components to the magnetized region, the magnetized region positioned such that, when dislodged from the magnetized region, the dislodged installable components fall into the bottom of the container.

2. The power tool bin of claim 1, wherein the container further includes an adapter bit holding region.

3. The power tool bin of claim 1, wherein the adapter bin holding area includes a friction rubbing region capable of holding in place one or more adapter bits.

4. The power tool bin of claim 1, wherein the adapter bin holding area further includes a magnetized region, the magnetized region strengthening retention of the adapter bits by the friction rubbing region.

5. The power tool bin of claim 1, wherein the attachment mechanism includes conforming geometry, the conforming geometry transferring some portion of the weight of the attachment to the body of an attached power tool.

6. The power tool bin of claim 1, wherein the attachment mechanism includes conforming geometry, the conforming geometry limiting rotation of the attachment when the attachment is attached to a power tool.

7. An attachment mountable to a power tool, the attachment comprising:
a magnetized region, the magnetized region including a magnet that magnetically retains a plurality of installable components; and
an adapter bit region capable of holding adapter bits.

8. The attachment of claim 7, wherein the adapter bit region is a magnetized region capable of holding in place one or more adapter bits.

9. The attachment of claim 7, wherein the adapter bit region includes a friction rubbing region capable of holding in place one or more adapter bits.

10. The attachment of claim 7, wherein the adapter bit region includes detents to hold in place one or more adapter bits.

11. The attachment of claim 7, wherein the adapter bit region includes a deformable region, the deformable region holding in place one or more adapter bits.

12. The attachment of claim 7, wherein the attachment further includes a bin region positioned to catch components dislodged from the magnetized region.

13. The attachment of claim 7, wherein the bin region has an attached movable lid or cover.

14. The attachment of claim 7, wherein the bin region has a removable lid or cover.

15. An attachment mountable to a handheld drill, hammer driver, impact driver, or similar device that installs or removes screws, bolts, nuts, or other fasteners or installable components, the attachment comprising:
a magnetized region that may hold one or more installable components; and
a bin region that may hold non-magnetic installable components and/or catch components dislodged from the magnetized region.

16. The attachment of claim 15, wherein the bin region is also magnetized.

17. The attachment of claim 15, wherein the bin region has an attached movable lid or cover.

18. The attachment of claim 15, wherein the bin region has a removable lid or cover.

19. An attachment mountable to a power tool, the attachment comprising:
a first region that magnetically holds a plurality of installable components;
a second region configured to hold tool bits;
a third region that conforms to the power tool in such a manner that it makes use of existing geometry and existing attachment points to support some portion of the weight of the attachment with the power tool and to stop the attachment from twisting relative to the power tool.

20. The attachment of claim 19, wherein the second region is a magnetized region capable of holding in place one or more adapter bits.

21. The attachment of claim 19, wherein the second region is a friction rubbing region capable of holding in place one or more adapter bits.

22. The attachment of claim 19, wherein the second region uses detents to hold in place one or more adapter bits.

23. The attachment of claim 19, wherein the second region uses a deformable region or springs to hold in place one or more adapter bits.
